(19) United States
(12) Patent Application Publication
(10) Pub. No.: US 2016/0090202 A1
(43) Pub. Date: Mar. 31, 2016

(54) SYSTEM AND METHOD FOR PREPARING AND PACKAGING PICKLED FOODS

(71) Applicant: HomeGrown & Happy LLC, Kansas City, MO (US)

(72) Inventors: Timothy B. Newman, Slater, MO (US); Christine M. Sanders, Kansas City, MO (US); Ginger C. Newman, Slater, MO (US); Jason M. Sanders, Kansas City, MO (US)

(21) Appl. No.: 14/863,062

(22) Filed: Sep. 23, 2015

Related U.S. Application Data
(60) Provisional application No. 62/055,425, filed on Sep. 25, 2014.

(51) Int. Cl. B65B 51/02; B65B 7/02; B65B 63/00; B65B 35/10; B65B 43/42; B65B 61/04; A23L 1/218; B65B 25/00

(52) U.S. Cl. CPC B65B 51/02; A23L 1/218; B65B 7/02; B65B 25/001; B65B 35/10; B65B 43/42; B65B 61/04; B65B 63/00; A23V 2002/00

(57) ABSTRACT

A system and method for making, cutting, and packaging pickled food items, such as pickled vegetables. The system is automated using a control computer or other controller subsystem. The system includes a conveyor for transporting pouches through the system. The pouches are optionally filled with spices and flavoring, liquids such as brining liquids for maintaining moisture of the vegetables placed within the pouch, a rotating drum for loading pickled vegetables into the pouches, a blade assembly for cutting the vegetables into portions, and a sealing device for sealing the pouches.

### CROSS-REFERENCE TO RELATED APPLICATION

This application claims priority in U.S. Provisional Patent Application No. 62/055,425, filed Sep. 25, 2014, which is incorporated herein by reference.

### BACKGROUND OF THE INVENTION

1. Field of the Invention

The present invention relates generally to a system and method for food preparation, and more specifically to a system and method for preparing pickled food items in pieces into a resealable pouch for bulk and/or individual servings.

2. Description of the Related Art

Existing pouched pickled foods are pouched in single unit servings, with no further processing such as cutting, spearing, or chunking to create ease of use for sharing, snacking and consuming in pieces. The present invention addresses this problem by creating a finished product in segments, then packaging them in single-serve and/or bulk serve consumer packages (single snack pouch or a family pack of pickle spears, chunks, pieces etc.). The existing pouched pickled foods also do not provide a resealable pouch package option, which this current invention also addresses.

Heretofore there has not been available a system or method for the preparation of pickled foods with the advantages and features of the present invention.

### SUMMARY OF THE INVENTION

The present invention generally provides a system and method for preparing pickled foods in segments, spears, chips, or pieces. The process automatically spices a pouch and slices the pickled food item (e.g., a pickled cucumber, commonly simply referred to as a “pickle”) directly into the pouch, which is then heat-sealed and sent to the bath or steamer for sterilization and shipping.

### BRIEF DESCRIPTION OF THE DRAWINGS

The drawings constitute a part of this specification and include exemplary embodiments of the present invention illustrating various objects and features thereof

FIG. 1 is a diagram representing a process of practicing a preferred embodiment of the present invention.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning For the purposes of this application, the word “pickle” can refer to any pickled food item, including any fruits and vegetables.

### II. Preferred Embodiment Packaging System 2

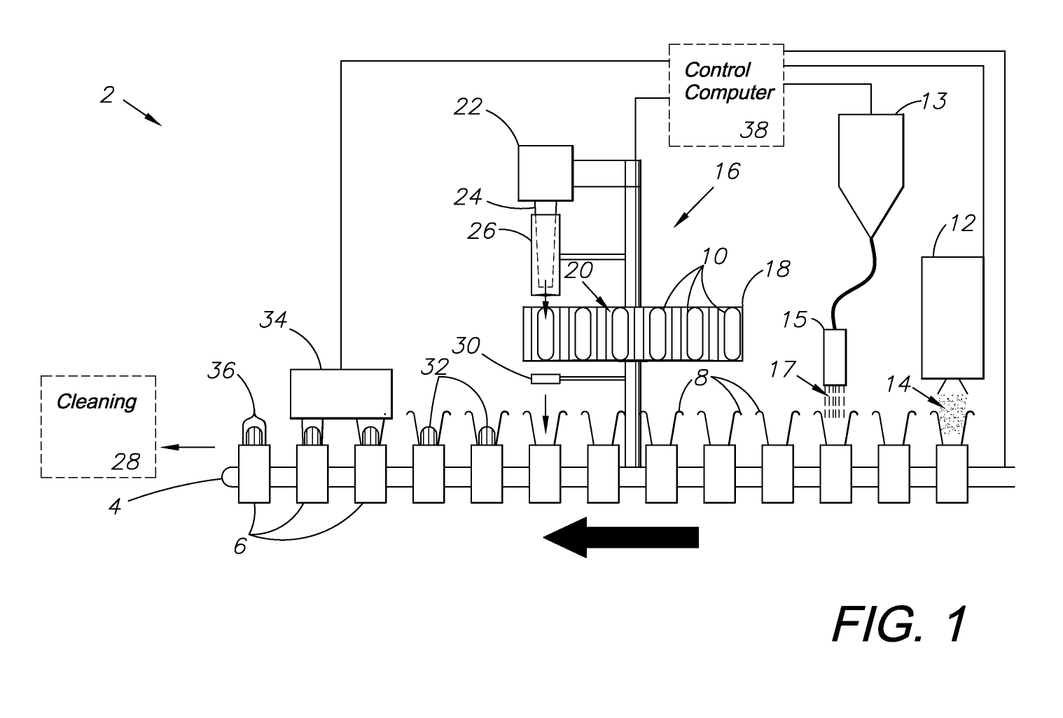

FIG. 1 shows a diagrammatic representation of a pickle preparing process via a packaging system 2. A number of open pouches 8 are carried along a conveyor system 4 beneath a loading assembly 16 including rotating drum 18 containing pickles 10 within individual compartments 20. The open pouches 8 are carried in pouch receivers 6 or otherwise are temporarily contained by the conveyer 4. An optional spice dispenser 12 may introduce various spices 14 to the open pouch 8. A similar liquid station 13 could apply liquids 17 to the pouch as well, via a juice dispenser 15, to ensure the pickles stored in the pouch remain moist.

The spice dispenser 12 could dispense any sort of powdered element, such as seasonings, spices, sweeteners, or artificial flavors (e.g. artificial grape, cherry, or other fruit flavors) or natural flavors.

The liquid station dispenses liquids such as a brining solution, vinegars, water, flavored water, or other liquids.

An air cylinder 22 forces each individual pickle 10 through a blade 30 or series of blades with a piston 24 located in a housing 26, and directly into the open pouch 8 located beneath the blade and air cylinder. This transforms the pickles into cut pickle slices 32. The blades are adjustable and can force the pickles to be sliced into chips, spears, chunks, or any other conceivable shape. Optionally, instead of a blade or in conjunction with the blade, the pickled food elements could be formed or pressed or cut or otherwise made into shapes of varying types.

Once the pickle portions 32 are in an individual pouch 8, the pouch is carried through a heat sealer 34 to semi-permanently seal the pouch, transforming it into a sealed pouch 36, until consumption by an end-user, and the pouch is carried off to a cleaning station 28, to be sanitized in a water bath or steamer.

The sealed pouches 36 may be resealable upon being opened by end-users. This can be done through a zip-top opening common in plastic storage bags, reusable adhesive, or some other means of resealing the pouches.

The pouches may have perforations which allow portions to be separated, wherein each portion contains a serving of pickled foods. These can be pulled apart and enjoyed separately. The pouches may be in a horizontal or vertical arrangement.

A controller, such as a control computer 38, automates all of the processes of the system 2. The control computer 38 is programmed to time when each process occurs.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A food preparation system comprising:
a conveyor system comprising a plurality of containment units for transporting pouches in a first, open configuration and a second, sealed configuration;
a rotating drum containing pickled food element, said rotating drum located in proximity to said pouches in said first, open configuration;
an air cylinder configured to transfer said pickled food element from said rotating drum into said pouches;
a blade assembly positioned between said air cylinder and said pouches, said blade assembly configured to cut said pickled food element into cut portions;
a sealer configured to seal said pouches, thereby converting them from said first, open configuration to said second, sealed configuration; and
a controller configured to control said conveyor system, said rotating drum, said air cylinder, and said sealer.

2. The system of claim 1, further comprising:
a flavoring dispenser positioned in proximity to said conveyor system and said pouches in said first, open configuration, said flavoring dispenser configured to dispense flavoring elements into said pouches; and
said flavoring dispenser controlled by said controller.

3. The system of claim 2, wherein said flavoring elements are selected from the list comprising: spices; seasonings; artificial flavors; natural flavors; and sweeteners.

4. The system of claim 1, further comprising:
a liquid dispenser positioned in proximity to said conveyor system and said pouches in said first, open configuration, said liquid dispenser configured to dispense liquids into said pouches; and
said liquid dispenser controlled by said controller.

5. The system of claim 4, wherein said liquids are selected from the list comprising: a brining solution; vinegar; water; and flavored water.

6. The system of claim 1, further comprising:
said pouch including at least one perforation line configured to separate the pouch into at least two compartments;
each of said at least two compartments sealed separately from the other compartments; and
said compartments capable of being separated by tearing along said perforation line.

7. The system of claim 1, further comprising:
said sealer configured to create a resealable seal onto said pouches; and
wherein said resealable seal is selected from the list comprising: reusable adhesive; a zip-top opening; and a flap.

8. The system of claim 1, further comprising:
a cleaning station configured to clean said pouches in said second, sealed configuration; and
said cleaning station selected from a list comprising: a water bath; and a steamer.

9. A method of preparing and packaging pickled foods, the method comprising the steps:
adding a flavored mixture to a pouch in an first, opened configuration;
adding a liquid substance to said pouch in said first, opened configuration;
conveying a pickled food element to said pouch in said first, opened configuration;
slicing said pickled food element with a blade structure, said pickled food element thereby configured to be converted into food portions and said portions being placed into said pouch;
sealing said pouch with a sealer, thereby converting said pouch into a second, sealed configuration; and
cleaning said pouch with a cleaning station.

10. The method of claim 9, further comprising the steps:
conveying said pouch in said first, open configuration with a conveyor system controlled by a controller;
adding said flavored mixture to said pouch with a flavor dispenser;
adding said liquid substance to said pouch with a liquid dispenser;
conveying said pickled food element through said blade structure and into said pouch with an air cylinder located in proximity to a rotating drum containing said pickled food element; and
controlling said flavor dispenser, liquid dispenser, air cylinder, rotating drum, and sealer with said controller.

11. The method of claim 9, wherein said flavored mixture is selected from the list comprising: spices; seasonings; artificial flavors; natural flavors; and sweeteners.

12. The method of claim 9, wherein said liquid substance is selected from the list comprising: a brining solution; vinegar; water; and flavored water.

13. The method of claim 9, wherein:
said pouch includes at least one perforation line configured to separate the pouch into at least two compartments;
each of said at least two compartments sealed separately from the other compartments; and
said compartments capable of being separated by tearing along said perforation line.

14. The method of claim 9, wherein:
said sealer configured to create a resealable seal onto said pouches; and
wherein said resealable seal is selected from the list comprising: reusable adhesive; a zip-top opening; and a flap.

15. The method of claim 9, wherein said cleaning station comprises a cleaning process selected from a list comprising: a water bath; and a steamer.
